(19) United States
(12) Patent Application Publication
(10) Pub. No.: US 2003/0161993 A1
(43) Pub. Date: Aug. 28, 2003

(54) Method and device for the production of multi-layered actuators

(76) Inventors: Thomas Biesinger, Rutesheim (DE); Thomas Schulte, Stuttgart (DE); Marianne Hammer, Stuttgart (DE); Stefan Henneck, Gerlingen (DE); Warren Suter, Stuttgart (DE); Friederike Lindner, Gerlingen (DE); Georg Hejtmann, Pommelsbrunn (DE)

Correspondence Address: KENYON & KENYON, ONE BROADWAY, NEW YORK, NY, 10004, US

(21) Appl. No.: 10/240,346

(22) PCT Filed: Mar. 20, 2001
(86) PCT No.: PCT/DE01/01053

(30) Foreign Application Priority Data
Apr. 1, 2000 (DE) 10016429.3

(51) Int. Cl. B32B 3/10

(52) U.S. Cl. 428/132; 428/131

(57) ABSTRACT

A method of manufacturing multilayer actuators is described, in which films (1), known as green films, having regions applied thereon made of metal plating to implement electrodes, are processed into compressed multilayer composite elements before a sintering step. Film elements (4), whose area defines the cross-sectional area of a finished actuator, are individually separated from the green film (1) having metal plating and stacked into a film stack to prepare for the manufacture of a multilayer composite element. Furthermore, a device having separating means (31, 32, 33, 35) for performing the method is described, in which the separating means is designed for the purpose of individually separating film elements (4), whose area defines the cross-sectional area of a finished actuator, from the green film (1) and stacking the separated film elements (4) directly afterward.

The present invention relates to a method and a device for manufacturing multilayer actuators.

### BACKGROUND INFORMATION

Multilayer actuators are generally made of piezoelectric or electrostrictive ceramics which display a change in length in the range from 0.1 to 0.3%, for example, upon application of an electrical field. The field strengths necessary for this purpose are of the magnitude of several thousand V/mm. In order to be able to operate actuators of this type using average control voltages of, for example, 100 to 300 V, a multilayer construction made of alternating ceramic/electrode layers is used. The layer thickness of the individual sintered layers made of ceramic is, for example, in the range from 80 to 100 μm, and that of the sintered electrode layers is less than 5 μm. Due to the comparatively small layer thickness, the necessary field strengths may be achieved at the individual layers between the electrodes even with the control voltages indicated above.

The manufacture of actuators includes multiple method steps:

First, for example, ceramic material in powdered form is processed together with an organic binder and a solvent, e.g., water or organic solvent, into a suspension, which is called slip. The slip is poured onto a carrier band and dried in a defined layer thickness in a continuous method. After the drying step, the dried slip, which is now in the form of a flexible, handleable green film, may be pulled off the carrier film.

The green film, with or without the carrier band, is provided with a metal plating, in order to produce electrodes from the metal plating. The application of the metal plating may be implemented, for example, by a screen printing method, by sputtering, or by vapor deposition. The green film provided with a metal plating is stacked and laminated without the carrier band.

“Lamination” is understood to mean the pressing together of the films at a defined temperature. For multilayer actuators, stacking and laminating is normally performed in the manifold panel. I.e., a large number of individual elements are mounted on each film. The films are stacked on top of one another in such a way that the individual elements lie as exactly as possible on top of one another. The separation of the actuators from stacks having a total height of up to 100 mm is comparatively costly. After the separation, a multilayer composite element is obtained, which must pass through a subsequent thermal process including a debinding step and a sintering step. In the debinding process, the organic components are expelled. In the following sintering step, the ceramic particles are “baked.” Due to the separation, which is not without problems, a subsequent processing step, in which the lateral surfaces of the actuators are ground, is still usually necessary after the sintering procedure.

However, even the lamination procedure of the film stack is subject to disadvantages. For a high-quality lamination procedure, it is necessary to heat the film stack uniformly and apply pressure to it uniformly. For large overall heights and areas of the film stack, it is possible only with difficulty to heat the entire film stack uniformly. A preheating step which is too long has the disadvantage that organic components from the green film may possibly be subject to changes, e.g., embrittlement, which may lead to inhomogeneities in the finished components. Furthermore, air is always enclosed between the film layers during stacking of the green films. During lamination, care must be taken to allow the air to escape completely. For large film stacks, it is highly probable that air bubbles will nonetheless remain.

These types of air bubbles may destroy the component as late as the debinding process if the air compressed in the air bubble after lamination expands at the debinding temperatures. The consequence is frequently formation of cracks in the actuator.

### OBJECTS AND ADVANTAGES OF THE INVENTION

The present invention has the object of improving the manufacture of multilayer actuators, particularly so that higher output rates may be implemented and the manufacturing cost may be reduced in this way.

This object is achieved by the features of claims 1 and 4.

Advantageous refinements of the present invention are described in the subclaims.

The present invention first relates to a method for manufacturing multilayer actuators, in which films, which include a flexible binder, in which piezoelectric and/or electrostrictive material particles are embedded, green films, having regions applied thereon made of metal plating for implementing electrodes, are processed into compressed multilayer composite elements before a sintering process. The basic idea of the present invention is therefore that film elements, whose area defines the cross-sectional area of a finished actuator, are individually separated from the green film having metal plating, e.g., cut out or stamped out, and the film elements are stacked into a film stack to prepare for the manufacture of a multilayer composite element. Through this procedure, accurately shaped film elements may be manufactured, due to which a reworking process of the component after the sintering procedure may be dispensed with, since the surfaces are sufficiently smooth. The geometry of the film elements selected during separation is subjected to a certain shrinking procedure due to the subsequent sintering procedure, however, this has the same effect on all film elements, so that the uniformity of the surfaces obtained is not significantly impaired. Furthermore, using individual separation, complex geometries may be implemented, e.g., actuators which are polygonal, oval, annular, or round in cross-section. The exact separation of polygonal, oval, annular, or round actuators from laminated manifold panels having comparatively large overall heights typically causes great difficulty. In addition, film stacks which have the area of the actuators to be produced, except for the shrinkage, may be laminated better, since a more favorable distribution of the lamination pressure results, height differences between regions of the green film provided with electrodes and regions without electrodes have hardly any disadvantageous effect during lamination, the entire stack may be heated more rapidly and uniformly, and, in addition, air may escape more easily from interstices between the stacked film elements. In addition, incorrectly printed electrodes may be easily sorted out even during separation, which results in a significant reduction in actuators which must be disposed of as rejects.

In order to design the stacking procedure of the film elements effectively, it is further suggested that every separated film element be stacked directly after termination of the separation procedure, before the separation of the next film element. In this case, it is preferable for the film elements to reach the stacking location, in the position in which they were separated, after the shortest possible distance. In this way, the film elements may be prevented from tipping, for example, before stacking.

For a device for manufacturing multilayer actuators from green film, preferably having regions applied thereon made of metal plating for implementing electrodes, which includes separation means, such as cutting or stamping devices for separating the green films, the basic idea of the present invention is that the separating means are laid out for the purpose of individually separating film elements from the green film whose area defines the cross-sectional area of the finished actuator and receiving the separated film elements in a film stack immediately after termination of the separation procedure. In this way, the separation of film elements and their stacking may be implemented almost as one working step, which has a positive effect on the manufacturing cost of the actuators.

In a further preferred embodiment of the present invention, the separation means have a separation tool, which is adjoined by a stacking unit in which the separated film elements are received. This represents a relatively simple option for stacking the film elements directly downstream from the separation procedure.

In an additional advantageous embodiment of the present invention, the stacking unit includes a recess for receiving the film elements, whose cross-section corresponds to the area of the separated film elements, and in which a stamping element is guided whose position fits the film stack height, i.e., the instantaneous position of the stamp is determined by the film stack height. Through this procedure, first, exact stacking of the film elements is achieved, since they are laid precisely positioned on one another in the recess. Furthermore, the tracking of the stamping element ensures that the path to the stacking location for separated film elements is always uniformly small. Correspondingly, a separated film element may also be reliably prevented from tipping until it reaches the stacking location.

In order to also be able to use the stacking unit for laminating film elements, it is further suggested that the stacking unit be heatable.

In this connection it is preferable for the stamping element to be usable in the stacking unit with a corresponding counterstamp, e.g., a punch, which would be present in any case, for laminating the film elements. Due to this measure it is not necessary to place a film stack into a further tool for the lamination. Preferably, the stamping element and possibly the counterstamp may be moved hydraulically to apply a predefined pressure to the film stack.

In a further preferred embodiment of the present invention, one or more ventilation channels are introduced into the punch. This allows the formation of a partial vacuum in the matrix to be prevented when the punch pulls back after a completed punching operation at very high punching speeds, which could cause already punched film parts to be raised up.

In a preferred embodiment of the present invention, the separation tool also includes a cutting edge which is arranged on the receiving side of the recess of the stacking unit.

In an alternative approach, which is equally simple, the separation tool includes a punch which is situated over the receiving side of the recess of the stacking unit.

### DRAWING

Various exemplary embodiments of the present invention are illustrated in the drawing and described in more detail with reference to further advantages and characteristics.

FIGS. 1a to c

show the manufacturing method of a multilayer actuator, explained in three schematically illustrated method stages,

FIG. 2 shows a device for stamping out and laminating film elements from a green film in a schematic side view,

FIG. 3 shows a device for cutting out and laminating film elements from a green film in a schematic side view, and

FIGS. 4a to c

show a method used previously for manufacturing actuators, explained in three schematically illustrated method stages.

### DETAILED DESCRIPTION OF THE EMBODIMENTS

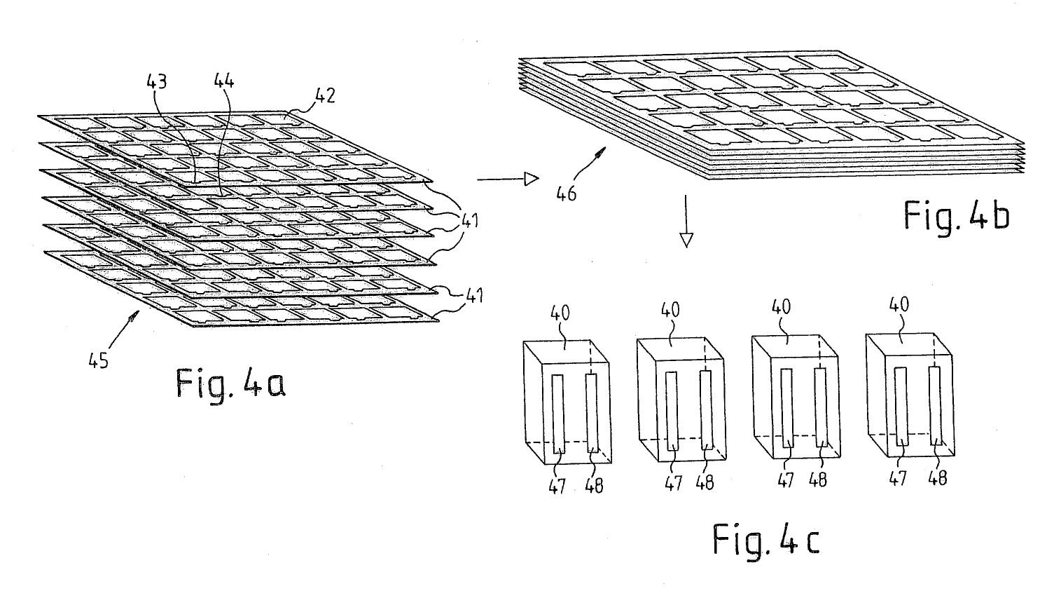

FIGS. 4a to c illustrate the conventional manufacture of multilayer actuators through three schematically illustrated method stages. First, green films 41 are produced and provided with metallic electrodes 42. The green films having electrodes 42 are, as shown in 4a, stacked on one another in such a way that the electrode surfaces lie over one another in the vertical direction and terminal lugs 43, 44 are led outward alternating from green film to green film. Such a film stack 45 is laminated as shown in FIG. 4b, i.e., the film stack is compressed under pressure and elevated temperature. The overall height of laminated film stacks in the manifold panel may be up to 100 mm.

The lamination of stack blocks this large is not without technological problems. Merely the application of a uniform surface pressure onto the green films is difficult, since the transition from electrode surfaces to electrode-free regions on the green film results in differences in height which cause differing pressure profiles in the film stack.

Furthermore, it is hardly possible to heat an entire large film stack uniformly. In the event, for example, outer regions of the film stack are heated too long, embrittlement of the binder, which, as a rule, is an organic substance, may occur. This results in inhomogeneities in the laminated stack, which may have an unfavorable effect on the debinding and the sintering procedure.

Finally, the inclusion of air bubbles cannot always be avoided during stacking of the green films. The lamination procedure is then to be carried out in such a way that the enclosed air may escape. However, in large stacks, there is a high probability that air bubbles will remain. Enclosed air bubbles often cause, as already described above, permanent damage to individual components during the debinding process.

As shown in FIG. 4c, multilayer composite elements 40 are cut out of a laminated film stack. The electrode lugs alternately led out are schematically illustrated by rectangles 47, 48 on multilayer composite elements 40.

Separated multilayer composite elements 40 are sintered and normally reworked in a subsequent method step (not shown). Generally, unacceptably coarse surfaces arise during the separation of multilayer composite elements 40 from the film stack, which must be evened out, for example by grinding.

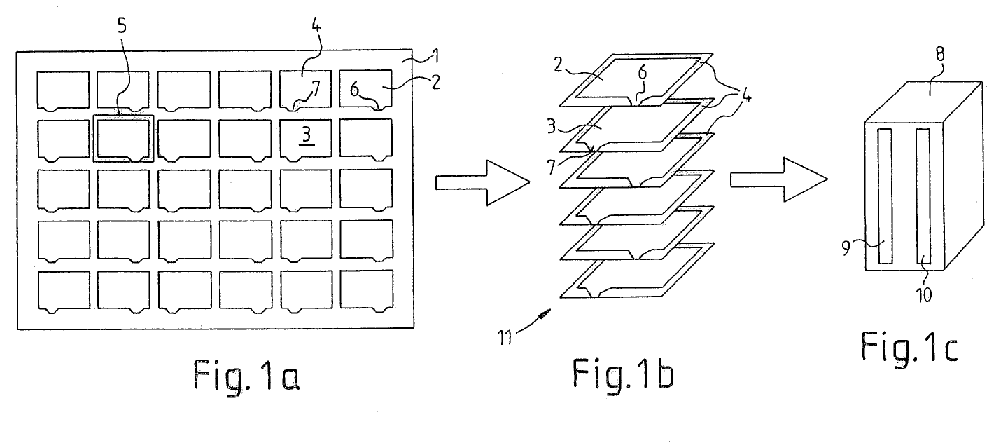

FIGS. 1a to c explain a method, using which the disadvantages of the typical method may be avoided, in three schematically illustrated process stages.

The starting point of the method is again the manufacture of green films 1, onto which electrodes 2, 3 are applied (compare FIG. 1a).

Individual film elements 4 are now, for example, stamped out of a green film 1 having electrodes 2, 3 and stacked on top of one another as shown in FIG. 1b.

A stamping cut is schematically indicated in FIG. 1a by rectangle 5.

Film elements 4 are again stacked on top of one another in such a way that alternating terminal lugs 6, 7 are led on the electrodes 2, 3 positioned thereon up to an external cut edge.

Such a film stack made of film elements 4 is now individually laminated, so that a multilayer composite element 8 as shown in FIG. 1c arises. Terminal lugs 6,7 led out are illustrated on multilayer composite element 8 by rectangles 9, 10. Each layer of the actuator may have voltage applied to it via terminal lugs 6,7.

The lamination of film stacks 11 shown in FIG. 1b is comparatively simple, since film stack 11, which has a small cross-sectional area, may be heated uniformly, the enclosure of air bubbles is not problematic, and, in addition, the application of a homogeneous surface pressure to the film stack may be implemented more easily, since the electrode-free regions lie on edge of the film stack.

A multilayer composite element 8 as shown in FIG. 1c only requires one debinding and sintering step for manufacture of a finished multilayer actuator. Reworking of surfaces is no longer necessary in the best case, since the film elements may individually be separated and stacked sufficiently precisely to obtain uniform lateral surfaces.

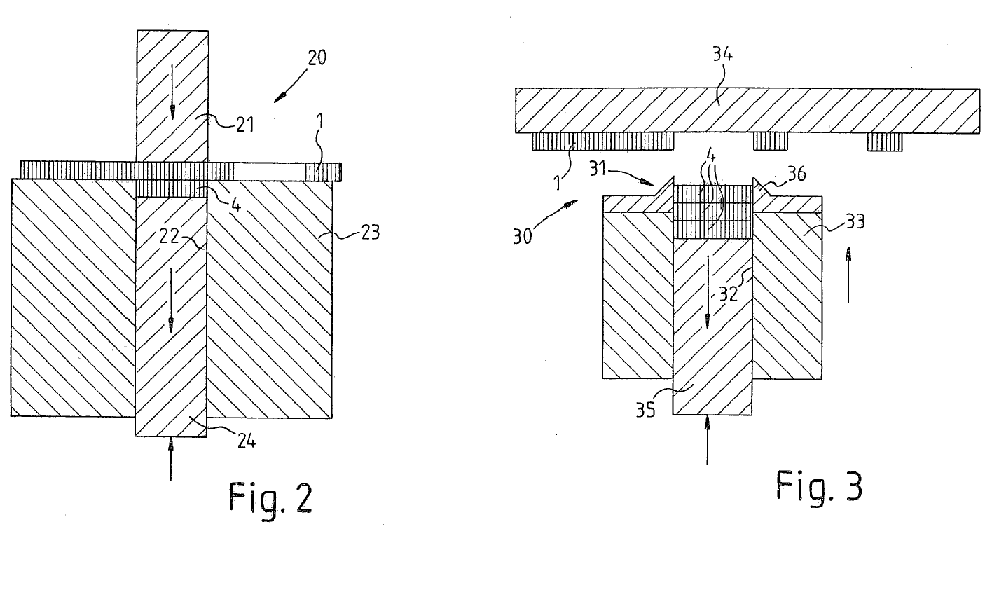

A device 20 for stamping out film elements 4 is illustrated in a schematic sectional view in FIG. 2. Film elements 4 are separated using a punch 21. For this purpose, either green film 1 having electrodes is moved under the stamping device or the stamping device is positioned in relation to green film 1.

A recess 22 is provided in a stacking unit 23 directly below punch 21. Recess 22 essentially corresponds in cross-section to the area and shape of stamped-out film elements 4, so that stamped-out film elements 4 fall into recess 22.

Therefore, exact stacking of the film elements takes place directly after the stamping procedure and before the next film element is stamped out.

A stack stamp 24, which is hydraulically movable, for example, and whose position adjusts to the growing film stack in recess 22, is arranged in recess 22. The cross-section of stack stamp 22 preferably corresponds to the cross-section of recess 22.

Through this procedure, controlled stacking of film elements 4 may be achieved. As soon as the film stack has the desired number of film elements, the lamination procedure may also occur in stacking unit 23. For this purpose, stacking unit 23 is heated using heating means (not shown), pressure being applied to the film stack via the stack stamp and a suitable counterstamp, e.g., punch 21.

The result is then a multilayer composite element which is very homogeneously laminated and, in addition, already has comparatively exact surfaces.

An alternative device 30 for separating film elements 4 is illustrated in FIG. 3. In this device, the film elements are cut out using a cutting edge 36 on a cutting tool 31, which is situated on a stacking unit 33 around the receiving side of an adjoining recess 32. Cutting tool 31 and recess 32 have identical cross-sections.

A green film 1 is placed in front of cutting tool 31 on a carrier element 34.

To cut out a film element 4, stacking unit 33, having cutting tool 31 arranged thereon, is moved toward green film 1, which is at a suitable position, until green film 1 is cut completely through. Green film 1 may also be moved in relation to cutting tool 31. The cut on the green film may be positioned either by moving the film or by moving the cutting tool.

Cut-out film elements 4 are received directly by recess 32, which follows cutting tool 31.

In order to achieve defined stacking, a hydraulically guided stack stamp 35 is used also in this embodiment; the stack stamp adjusts itself to the height of stack film elements 4. Stack stamp 35 has the same cross-section as recess 32.

If the desired number of film elements 4 has been received in stacking unit 33, the lamination of film elements 4 may also be performed therein. For this purpose, a counterstamp (not shown), for example, may be used on the side of cutting tool 31, so that film elements 4 may have a defined pressure applied to them via stack stamp 35 and the counterstamp. The necessary uniform heating of the film elements may be achieved by heating stacking unit 33.

Homogeneously laminated multilayer composite elements, which merely have to be debinded and sintered in order to obtain a multilayer actuator, may also be produced using device 30 for cutting the film elements.

What is claimed is:

1. A method for manufacturing multilayer actuators, in which films which include a flexible binder, in which piezoelectric and/or electrostrictive material particles are embedded, known as green films (1), having regions made of metal plating applied thereon to implement electrodes (2, 3), are processed into compressed multilayer composite elements (8) before a sintering step, wherein film elements (4), whose area defines the cross-sectional area of a finished actuator, are individually separated from the green film (1) with metal plating and stacked into a film stack in preparation for the manufacture of a multilayer composite element (8).

2. The method as recited in claim 1,
wherein each separated film element (4) is stacked up before the separation of the next film element.

3. The method as recited in one of the preceding claims,
wherein the manufacture of the multilayer composite elements (8) is performed by separate compression of a film stack (11) while it is heated.

4. A device for manufacturing multilayer actuators from green film (1), which includes separating means (20, 30) for one of the green films, particularly for performing the method as recited in one of the preceding claims, wherein the separating means (20, 30) is designed for the purpose of individually separating film elements (4), whose area defines the cross-sectional area of a finished actuator, from the green film (1), and receiving a separated film element (4) in a film stack directly after the separating procedure and before the next film element is separated.

5. The device as recited in claim 4,
wherein the separating means has a separating tool (21, 31), which is adjoined by a stacking unit (23, 33) in which the film elements (4) are received.

6. The device as recited in claim 4 or 5,
wherein the stacking unit (23, 33) includes a recess (22, 32) for receiving film elements (4), whose cross-section corresponds to the area of the separated film elements, and in which a stack stamp (24, 35), whose position matches the film stack height is guided.

7. The device as recited in one of claims 4 to 6,
wherein the stacking unit (23, 33) is heatable.

8. The device as recited in one of claims 4 to 7,
wherein the stamping element (24, 35) in the stacking unit (23, 33) is usable with a corresponding counterstamp for laminating the film elements (4).

9. The device as recited in one of claims 4 to 8,
wherein the separating tool includes a cutting edge (36), which is situated on a receiving side of the recess (32) of the stacking unit (33).

10. The device as recited in one of claims 4 to 8,
wherein the separating tool includes a punch (21), which is situated over a receiving side of the recess (22) of the stacking unit (23).
